(19) United States
(12) Patent Application Publication
(10) Pub. No.: US 2008/0275734 A1
(43) Pub. Date: Nov. 6, 2008

(54) Method and Apparatus for Picture Archiving Communication System With STAT Workflow

(75) Inventor: Weng I. Lei, Mount Prospect, IL (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Medical Solutions USA, Inc., Malvern, PA (US)

(21) Appl. No.: 11/837,164

(22) Filed: Aug. 10, 2007

Related U.S. Application Data
(60) Provisional application No. 60/916,032, filed on May 4, 2007.

(51) Int. Cl. G06G 7/48; G06F 15/16; G08B 21/00

(52) U.S. Cl. 705/3; 340/540; 709/200

(57) ABSTRACT

A method for medical scan archiving and notifying medical professionals of a need for evaluation of the medical scan, having a capability to identify emergency condition data for medical patients and notify appropriate personnel of the emergency data pending within the system.

### CROSS-REFERENCE TO RELATED APPLICATIONS

This is a United States non-provisional application of U.S. provisional patent application Ser. No. 60/916,032 filed May 4, 2007 by Weng I Lei the entirety of which application is incorporated by reference herein.

### FIELD

The present invention relates to a system and method for medical data archiving. More specifically, the present invention provides a method and apparatus to archive medical data scans, the apparatus also configured with an intelligent message broadcast mechanism to alert medical professionals of the need to immediately evaluate urgent medical data scans and to retrieve outdated message broadcasts.

### BACKGROUND INFORMATION

Evaluation of medical data by medical professionals is a necessary and important process in medical care. Systems used by medical professionals must have the ability to accurately recall and represent data from medical tests to medical evaluative professionals. These systems may also allow for long term storage of the data to allow comparison of differing data sets over time. Evaluations are to be performed, in some instances, in a weekly time frame as no emergency exists for the patient. On other occasions, however, when an emergency is present, the data from medical tests must be evaluated quickly. In emergency situations, if medical professionals are not immediately present, the medical data goes unread and unevaluated, delaying patient care.

Conventional paging systems that send data to medical professionals often send data that is old or redundant causing the medical professional to spend valuable time clearing messages from the messaging system. These conventional paging systems do not clear old data from the system when needed.

There is therefore a need to provide a method and apparatus to notify medical professionals, such as radiologists, that examination of medical data should commence when data is ready.

There is a further need to provide a method and apparatus to minimize time lag between preparation of medical data and evaluation by medical professionals so that patients receive immediate care.

There is a still further need to provide a method and system that will minimize the need for emergency examination readings that are not necessarily needed to be read on an expedited basis.

There is also a need to provide a method and system that will discriminate between data types and subsequently allow notification of appropriate medical professionals based upon the data type required to be evaluated.

There is a further need to provide a method and system that has an intelligently designed messaging system such that messages that are beyond a certain age or wherein data has changed status during an intervening time interval, are retrieved by the system.

There is a further need to provide a method and system that has an intelligently designed message system such that messages are automatically sent to medical practitioners when an emergency situation is present for a patient that has an emergency medical scan to be read.

### SUMMARY

It is therefore an objective to provide a method and apparatus to notify medical professionals, such as radiologists, that examination of medical data should commence.

It is a further objective to provide a method and apparatus to minimize time lag between preparation of medical data and evaluation by medical professionals so that patients receive immediate care.

It is a still further objective to provide a method and system that will minimize the need for emergency examination readings that are not necessarily needed to be read on an expedited basis.

It is also an objective to provide a method and system that will discriminate between the data types and subsequently allow notification of appropriate medical professionals based upon the data type required to be evaluated.

It is a further objective of the method and system to provide an intelligently designed messaging system for the picture archiving system such that messages that are beyond a certain age or wherein data has changed status during the intervening time interval, are retrieved by the system.

It is a further objective to provide a method and system that has an intelligently designed message system such that messages are automatically sent to medical practitioners when an emergency situation is present for a patient, when a medical scan must be read.

The objectives are achieved as illustrated and described. An embodiment of the invention provides a method, comprising the steps of enrolling medical professionals in a computer system, creating a list of the medical professionals that desire to receive emergency broadcast transmissions, entering medical data about a patient, an urgency type for the patient, and a medical data type for the patient into the computer system, broadcasting a first message to the medical professionals that desire to receive emergency broadcast transmissions when an urgency type for the data is in an emergency status, conducting a second broadcast message to a medical professional with a medical professional type corresponding to the medical data type when the urgency type corresponds to a need for immediate reading of the medical data for the patient, and retrieving the broadcast message to the medical professional and conducting a replacement broadcast when the urgency type of the medical data changes from a first state to a second state.

In another embodiment of the invention, the urgency type for the patient is one of a modality categorization, an exam priority categorization, a study data categorization and a time categorization.

In another embodiment of the invention, the method further comprises verifying the urgency type for the patient after the step of evaluating the urgency type for the patient related to the medical data and before the step of conducting the second broadcast message to the medical professional. The method may also comprise the step of reading the medical data by a medical professional.

In yet another embodiment of the invention the method further comprises changing the urgency type in the data archival system after the reading of the medical data by the medical professional. The medical data type may be a magnetic resonance image or a computed tomography image.

In another embodiment of the invention, the method provides for the additional step of creating a notification list of medical professionals of a same medical professional type; wherein the conducting of the second broadcast message to the medical professional with the medical professional type corresponding to the medical data type when the urgency type corresponds to a need for immediate reading of the medical data for the patient is done through contacting medical professionals on the notification list.

In another embodiment of the invention, a program storage device readable by machine, tangibly embodying a program of instructions executable by the machine to perform method steps for medical scan archiving and notifying medical professionals of a need for evaluation of the medical scan is provided, the method, comprising enrolling medical professionals in a computer system creating a list of the medical professionals that desire to receive emergency broadcast transmissions, entering medical data about a patient, an urgency type for the patient, and a medical data type for the patient into the computer system, broadcasting a first message to the medical professionals that desire to receive emergency broadcast transmissions when an urgency type for the data is in an emergency status, conducting a second broadcast message to a medical professional with a medical professional type corresponding to the medical data type when the urgency type corresponds to a need for immediate reading of the medical data for the patient; and retrieving the broadcast message to the medical professional and conducting a replacement broadcast when the urgency type of the medical data changes from a first state to a second state.

In another embodiment of the invention the method accomplished by the program storage device is performed such that the urgency type for the patient is one of a modality categorization, an exam priority categorization, a study data categorization and a time categorization.

In another embodiment of the invention, the method achieved by the program storage device further comprises the step of verifying the urgency type for the patient after the step of evaluating the urgency type for the patient related to the medical data and before the step of conducting the broadcast message to the medical professional.

In another embodiment of the invention, the method achieved by the program storage device further comprises reading the medical data by a medical professional.

In yet another embodiment of the invention, the method achieved by the program storage device further comprises: changing the urgency type in the data archival system after the reading of the medical data by the medical professional. The medical data types may be magnetic resonance images or computed tomography images.

In yet another embodiment of the invention, the method further comprises: creating a notification list of medical professionals of a same medical professional type; wherein the conducting of the broadcast message to the medical professional with the medical professional type corresponding to the medical data type when the urgency type corresponds to a need for immediate reading of the medical data for the patient is done through contacting medical professionals on the notification list.

An embodiment of the invention also provides an apparatus for medical data retention and medical professional notification, comprising a computer workstation configured to enter and display patient information medical data scans, a broadcast module, and a computer server connected to the computer workstation, the computer server configured to store the medical data scans patient information, the computer server also having a messaging module connected to the broadcast module, wherein the messaging module is configured to both activate the broadcast module to send a message to a medical professional at a location remote from the computer workstation and the computer server based upon a predefined status of the patient information and to accept and maintain a list of medical professionals qualified to receive an emergency broadcast, the messaging module further configured to retrieve previously conveyed messages when a status of data corresponding to the message has changed.

### BRIEF DESCRIPTION OF THE DRAWINGS

FIG. 1 is a exemplary method for picture archiving and message broadcasting mechanism.

FIG. 2 is an arrangement to perform the method of picture archiving and message broadcasting.

### DETAILED DESCRIPTION

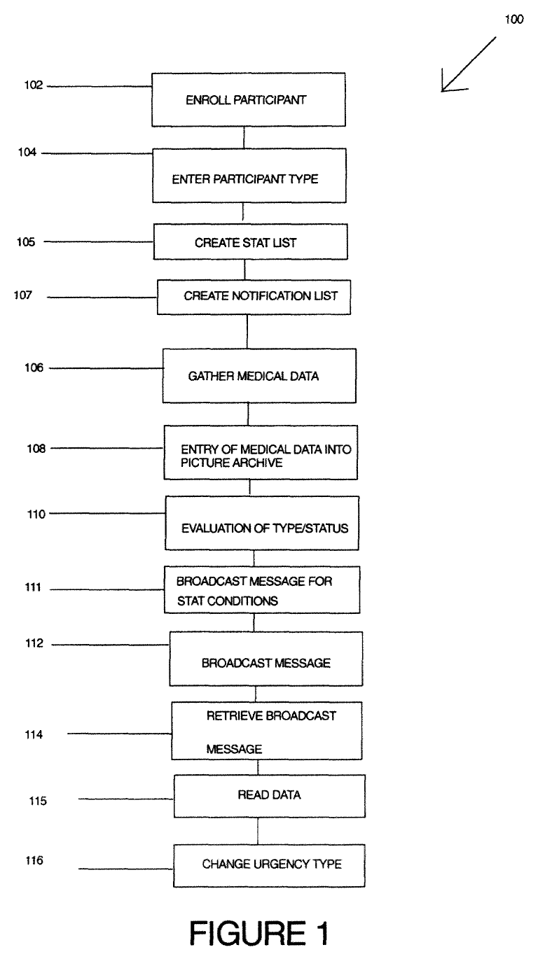

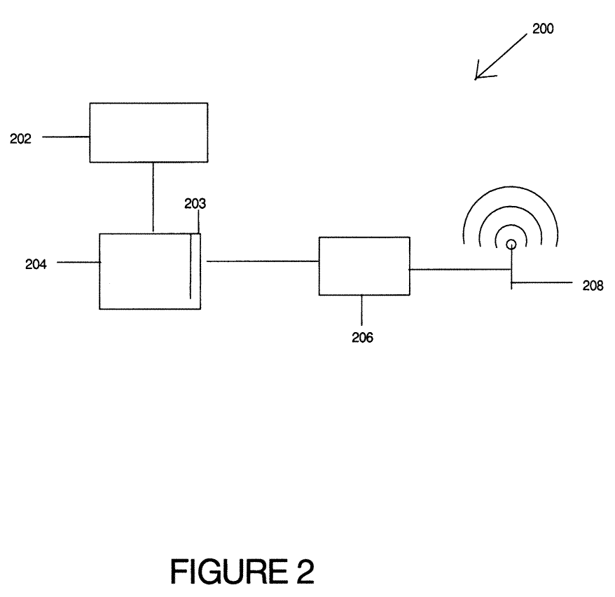

Referring collectively to FIGS. 1 and 2, an exemplary embodiment of a method 100 for medical scan archiving and notifying medical professionals of a need for evaluation of the medical scan is illustrated. The system 200 used for performing the method 100 is illustrated in FIG. 2. The method 100 comprises, in step 102, enrolling a medical professional in the system 200 and entering the medical professional's medical professional type in step 104. In one embodiment, the medical professional is a radiologist, however other types of medical professionals may also be enrolled into the system 200. As will be understood, more than one medical professional may be enrolled into the system 200 in accordance with method 100, such as dentists, who specialized in complex oral surgery and who evaluate complex data stored in data storage systems. Thus, several different types of medical professionals may be enrolled into the system 200 in accordance with method 100, and the method and system 100, 200 may categorize the medical professionals into discrete subgroups of areas of expertise. This can include, for example, a radiologist who specializes in reading magnetic resonance image as compared to computed tomography images. The system 200, in one embodiment, is capable of notifying the enrolled medical professional participants on an as-needed basis via communication devices accessible to the medical professionals. The communication device may be a mobile unit such as cellular telephone with text message capability, as a non-limiting example.

A list of medical professionals is then created in the system 200 in step 105 of the method 100 such that medical professionals that desire to receive information related to emergency situations, hereinafter termed as “Stat” messages or “Stat” data sets, may be communicated to the medical professionals in the list by the system 200. The list may also be populated such that times for availability of the differing individuals on the list are present as well as the medical specialty.

Next, medical data is gathered from the patient in step 106 of the method 100 for use by the system 200. The medical data gathered from the patient may be of various types, including those specifically pertaining to visual records of patients, such as magnetic resonance images, computed tomography scans, ultrasonic scans, upper and lower gastrointestinal series, angiographs and dental x-ray records, as non-limiting examples. In one embodiment, the system 200 is a picture archiving communication system (PACS). The medical data in one embodiment of the present invention are scans of the patient and provided in electronic format. The medical data may also be chemical analysis of patient body tissues or fluids that are required to be evaluated.

The medical data is then entered into and stored in the system 200 in step 108 of the method 100 such that the information is archived for future use, for example in a PACS system, or may be stored on digital video disk. The machinery used to obtain the medical data may be directly connected to the system 200 and fed into the system memory through a data connection port or data may be fed into the system 200 through other means, such as compact disc or digital video disk as non-limiting examples.

In addition to providing the medical data, an urgency type for the patient medical data and a medical data type for the patient are also entered into and stored in the system 200 in step 108 of the method 100. The urgency type for the patient medical data may be related to the needed priority of the evaluative results. The urgency type may be configured to use a modality type, an exam priority field, a required study date and time. Patient particular information may also be entered into the system 200 in step 108. Such information may include patients contact information and insurance information, as non-limiting examples. Other types of information may also be entered into the system 200 in step 108, such that properties are used to configure evaluation times.

In one embodiment, the data stored in the system 200 is downloaded into a computer server arrangement 204 of the system 200 The computer server 204 may be interconnected with other computer servers such that data freely flows between computer systems. Thus, a person analyzing the medical data can be in a different location than the place that the computer data is stored, allowing medical professionals flexibility in staffing at different locations.

In step 110, the system 200 evaluates the urgency type for the patient related medical data. A check is then conducted of the data in the system 200 to determine if any data sets are listed as “Stat” or emergency conditions. If any data sets within the system 200 are noted as “Stat”, then the system 200 automatically sends a message to recipients of the “Stat” list in step 111 of the method 100 that are on duty for receiving such messages. Members of the “Stat” list that are off duty for receiving such messages are precluded from any messages broadcast by the system 200.

Based upon the urgency type of the patient related medical data evaluated in step 110 of the method 100, a follow-up broadcast message is made by the system 200 to a medical professional with a medical professional type corresponding to the medical data type of the medical data in step 112. Broadcast messages may be made by computer email, or other electronic notification to the medical professional who is performing the evaluation.

In step 114, the broadcast message is retrieved from the medical professional by the system 200 when the urgency type of the medical data changes from a first state to a second state . The method 100 may also send out another broadcast message to medical professionals replacing the broadcast message previously retrieved in step 114 so that the professional has the most up to date information available. The system 200 may also be configured such that upon entry of information designating the data as “Stat”, the system 200 will send out a message/broadcast that a “Stat” data set is waiting to be analyzed. This broadcast can be done in any mode, regardless of whether the data is “Arrived”, “Verified”, “Dictated” and “Approved”.

The type of broadcast may also be varied such that a simple notification is made to a medical professional to go to a workstation 202 of the system 200 for viewing of the data. Alternatively, however, more complex data may be contained in the broadcast, including the actual data to be evaluated itself so that the medical professional does not need to go to the workstation 202.

The broadcast message may reside in the computer server 204 of the system 200 that is responsible for broadcasting messages to registered individuals. A messaging module 203, within the computer server 204 also examines/monitors the examination status of the data within the system 200. In one embodiment of the invention, the messaging module 203 tracks information within the system such that the patient data has an examination status of “Verified”, “Dictated” and “Approved” and sends out messages accordingly to medical professionals charged with reading the patient data. Broadcast messages are transmitted by the system 200 in method step 112, when, for example, the data to be evaluated has reached the “Verified” status (i.e. a doctor must analyze the data).

If the examination data satisfies a given configuration criteria, the messaging module 203 will send messages to all subscribers, such as in step 112, with the following content: patient name, study date and time, study instance UID (unique identification number), Modality, Exam Status and Procedure name. The UID is a unique identification number that is particular to the data of the particular data set for a patient. The system 200 uses the unique identification number in determining the current status of the data set, either “Arrived”, “Verified”, “Dictated” or “Approved”. In addition to checking the status of the examination for the status of “Arrived”, “Verified”, “Dictated” and “Approved”, when the status of the examination has changed during successive time periods, then the messaging module 203 recalls/deletes previously transmitted messages, as in step 114, onto the system 200 to ensure that the data presented to medical professionals is the most currently available. In the “Arrived” status, the images have been acquired and are present within the system 200. In the “Verified” status, an examination of the data has been verified by technologists that the correct number of images or data sets are present for reading and that the images are of the correct patient. In the “Dictated” status, the data has been evaluated by a medical professional and the results have been dictated as well as creation of a report pertaining to the data. In the “Approved” status, the diagnostic report has been finalized and approved by a staff radiologist, for example.

Referring to FIG. 2 illustrating the system 200, when the medical data (image) is read by a technologist, the technologist, through the workstation 202, sends a request to the server 204 to change the data status to “Verified”. In the “Verified” status, the data is ready to be evaluated. As a messaging module 203 resides in the server 204, the server 204 is able to update the broadcast module 206 to send information to broadcast module 206 and antennae 208 to the list of individuals authorized to receive such information, required in steps 111 and 112.

When a medical data set is dictated by a medical professional, the status is then changed to “Dictated” in the server 204 through the workstation 202. The data is then ready to be read by a further medical professional, if needed, for verification. The messaging module 203 that is part of the server 204 notifies appropriately designated individuals that the medical data is in the “Dictated” status, for example in step 112. The messaging module 203 may also identify the medical professional who dictated the data, the location of the dictation and the time and date of the dictation.

The data that has been “Dictated” may then be verified by another medical professional at the workstation 202, for example, and the status (type) changed to “Approved”. As will be understood, after the data has been changed to the “Dictated” status, the messaging module 203 within the server 204 may prepare a notification to the broadcast module 206 and antennae 208 to individuals who may be designated as performing the verification function, again as in step 112.

As described above, the method 100 and system 200 notify medical professionals that examination of medical data should commence. The method 100 and apparatus 200 also minimize time lag between preparation of medical data and evaluation by medical professionals so that patients receive immediate care.

The method 100 and system 200 also minimize the need for emergency examination readings that are not necessarily needed to be read on an expedited basis.

The method 100 and system 200 in accordance with an embodiment of the present invention also discriminate between data types and subsequently allow notification of appropriate medical professionals based upon the data type required to be evaluated.

In the foregoing specification, the invention has been described with reference to specific exemplary embodiments thereof. It will, however, be evident that various modifications and changes may be made thereunto without departing from the broader spirit and scope of the invention as set forth in the appended claims. The specification and drawings are accordingly to be regarded in an illustrative rather than in a restrictive sense.

What is claimed is:

1. A method, comprising:
enrolling medical professionals in a computer system;
creating a list of the medical professionals that desire to receive emergency broadcast transmissions;
entering medical data about a patient, an urgency type for the patient, and a medical data type for the patient into the computer system;
broadcasting a first message to the medical professionals that desire to receive emergency broadcast transmissions when an urgency type for the data is in an emergency status;
conducting a second broadcast message to a medical professional with a medical professional type corresponding to the medical data type when the urgency type corresponds to a need for immediate reading of the medical data for the patient; and
retrieving the broadcast message to the medical professional and conducting a replacement broadcast when the urgency type of the medical data changes from a first state to a second state.

2. The method according to claim 1, wherein the urgency type for the patient is one of a modality categorization, an exam priority categorization, a study data categorization and a time categorization.

3. The method according to claim 1, further comprising:
verifying the urgency type for the patient after the step of evaluating the urgency type for the patient related to the medical data and before the step of conducting the second broadcast message to the medical professional.

4. The method according to claim 1, further comprising:
reading the medical data by a medical professional.

5. The method according to claim 4, further comprising:
changing the urgency type in the data archival system after the reading of the medical data by the medical professional.

6. The method according to claim 1, wherein the medical data type is one of a magnetic resonance image and a computed tomography image.

7. The method according to claim 1, wherein the medical data type is a modality type contained in a picture archiving communication system.

8. The method according to claim 1, further comprising:
creating a notification list of medical professionals of a same medical professional type; wherein the conducting of the second broadcast message to the medical professional with the medical professional type corresponding to the medical data type when the urgency type corresponds to a need for immediate reading of the medical data for the patient is done through contacting medical professionals on the notification list.

9. A program storage device readable by machine, tangibly embodying a program of instructions executable by the machine to perform method steps for medical scan archiving and notifying medical professionals of a need for evaluation of the medical scan, comprising:
enrolling medical professionals in a computer system;
creating a list of the medical professionals that desire to receive emergency broadcast transmissions;
entering medical data about a patient, an urgency type for the patient, and a medical data type for the patient into the computer system;
broadcasting a first message to the medical professionals that desire to receive emergency broadcast transmissions when an urgency type for the data is in an emergency status;
conducting a second broadcast message to a medical professional with a medical professional type corresponding to the medical data type when the urgency type corresponds to a need for immediate reading of the medical data for the patient; and
retrieving the broadcast message to the medical professional and conducting a replacement broadcast when the urgency type of the medical data changes from a first state to a second state.

10. The program storage device according to claim 9, wherein the urgency type for the patient is one of a modality categorization, an exam priority categorization, a study data categorization and a time categorization.

11. The program storage device according to claim 9, wherein the method further comprises:
verifying the urgency type for the patient after the step of evaluating the urgency type for the patient related to the medical data and before the step of conducting the broadcast message to the medical professional.

12. The program storage device according to claim 9, wherein the method further comprises reading the medical data by a medical professional.

13. The program storage device according to claim 12, wherein the method further comprises:
changing the urgency type in the data archival system after the reading of the medical data by the medical professional.

14. The program storage device according to claim 9, wherein the medical data type is a magnetic resonance image.

15. The program storage device according to claim 9, wherein the medical data type is a computed tomography image.

16. The program storage device according to claim 9, wherein the method further comprises:
creating a notification list of medical professionals of a same medical professional type; wherein the conducting of the broadcast message to the medical professional with the medical professional type corresponding to the medical data type when the urgency type corresponds to a need for immediate reading of the medical data for the patient is done through contacting medical professionals on the notification list.

17. An apparatus for medical data retention and medical professional notification, comprising:
a computer workstation configured to enter and display patient information medical data scans;
a broadcast module; and
a computer server connected to the computer workstation, the computer server configured to store the medical data scans patient information, the computer server also having a messaging module connected to the broadcast module, wherein the messaging module is configured to both activate the broadcast module to send a message to a medical professional at a location remote from the computer workstation and the computer server based upon a predefined status of the patient information and to accept and maintain a list of medical professionals qualified to receive an emergency broadcast, the messaging module further configured to retrieve previously conveyed messages when a status of data corresponding to the message has changed.
